(19) United States
(12) Patent Application Publication
(10) Pub. No.: US 2013/0013445 A1
(43) Pub. Date: Jan. 10, 2013

(54) SYSTEM AND METHOD FOR PRODUCING AN ALBUM

(76) Inventor: Darcy L. Crociata, Mason, OH (US)

(21) Appl. No.: 13/544,335

(22) Filed: Jul. 9, 2012

Related U.S. Application Data
(60) Provisional application No. 61/505,183, filed on Jul. 7, 2011.

(51) Int. Cl. G06F 3/048; B42C 9/00; G06Q 30/00

(52) U.S. Cl. 705/26.5; 715/810; 412/1

(57) ABSTRACT

A computerized method may be used to create a photograph album from a digital photograph source. The method includes receiving an input selection from a user, which is entered through a computing device. The method also includes retrieving photographs and contextual content from a digital photograph database stored on a second computing device. The method also includes the one or more photographs and contextual content in a photo album. The method also includes compiling the photographs and contextual content into an arrangement. Finally, the method includes creating a finalized version of the photograph album.

### PRIORITY

This application claims priority to U.S. Provisional Patent Application Ser. No. 61/505,183, filed Jul. 7, 2011, entitled “SYSTEM AND METHOD FOR COMPILING AND PRODUCING A MULTIMEDIA ALBUM,” the disclosure of which is incorporated by reference herein.

### BACKGROUND

Scrapbooks, yearbooks, photo albums, and other related albums have been commonly used to maintain memories and catalog special moments in a person's life and enable them to share it with others. Various web-based photo sharing websites and photo print services (such as Snapfish and Flickr) allow users to upload, purchase, and share photos with one another.

With the advent of online social media and social networking platforms (such as Facebook, Myspace, and LinkedIn), users are also able to easily share photos, videos, stories, messages, and other content with friends and family.

While a variety of photo and digital media sharing tools and services have been made and used, it is believed that no one prior to the inventor has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a block diagram of a system for compiling and producing a multimedia album;

FIG. 2 depicts a flow chart diagram of a method for compiling and producing a multimedia album by the system depicted in FIG. 1;

FIG. 3 depicts an exemplary screen shot view of an introduction page;

FIG. 4 depicts an exemplary screen shot view of a date range page;

FIG. 5 depicts an exemplary screen shot view of a theme selection page;

FIG. 6 depicts an exemplary screen shot view of a journal entry page;

FIG. 7 depicts an exemplary screen shot view of a content-type selection page;

FIG. 8 depicts an exemplary screen shot view of a retrieval process page;

FIG. 9 depicts an exemplary screen shot view of one content selection page;

FIG. 10 depicts an exemplary screen shot view of another content selection page;

FIG. 11 depicts an exemplary screen shot view of yet another content selection page;

FIG. 12 depicts an exemplary screen shot view of a review page;

FIG. 13 depicts an exemplary screen shot view of a review page with a preview; and

FIG. 14 depicts an exemplary screen shot view of a review page with a preview.

The drawings are not intended to be limiting in any way, and it is contemplated that various versions of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, versions, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

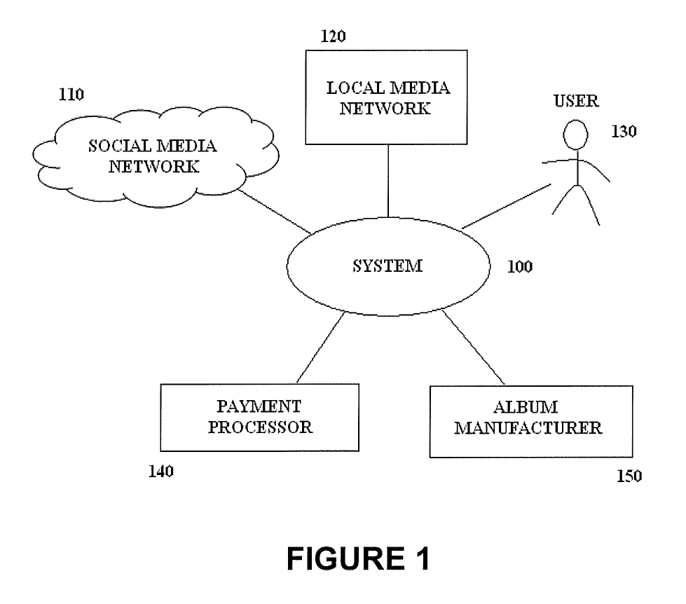

FIG. 1 depicts a block diagram of a system for compiling and producing a multimedia album. The multimedia album creation system (100) may be in communication with at least one social media network (110), at least one local media network (120), at least a first user (130), a payment processor (140), and an album manufacturer (150). The connections between the system (100) and the other networks enable inputs and data to be transferred to and from the system (100). The system (100) may comprise a software application that functions as a standalone application, as an application within a mobile or cellphone platform, as an application within a social networking service, or as an application within a website. The system (100) may include a computer or other suitable computing device having a memory or other computer readable medium operable to hold executable code able to carry out one or more instructions. It will be appreciated that in some instance the computer readable medium or memory may include non-transitory memory operable to store the executable code. The system (100) may further include a processor in communication with the computer readable medium or memory such that the processor may carry out the instructions of the executable code. The system (100) may also include a display, a user input device or any other suitable interfaces that would be apparent to one of ordinary skill in the art in view of the teachings herein.

The social media network (110) may include connections to services such as, but not limited to, Facebook, Twitter, Picasa, Flickr, MySpace, LinkedIn, or any other suitable social media network (11) as would be apparent to one of ordinary skill in the art in view of the teachings herein. The types of files and data transmitted between the social media network (110) and the system (100) may include, but is not limited to, photos, notes, comments, status updates, blog posts, etc., or any other pieces of information as would be apparent to one of ordinary skill in the art in view of the teachings herein.

The local media network (120) may include data stored on a local area network (not pictured), a local computer (not pictured), or a personal device (not pictured). Like the social media network (110), the types of files and data transmitted between the local media network (110) and the system (100) may include, but is not limited to, photos, movies, notes, comments, status updates, blog posts, etc.

The user (130) interacts with the system (100) via a local computer (not pictured), or a personal device (not pictured), such as a mobile phone or tablet. Here data relating to user inputs and selections may be transmitted from the user (130) to the system (100). The system (100) in return, may transmit information to build a graphical user interface (GUI) in which the user can provide inputs, selections, and interact with. It will be appreciated that in some instances, system (100) may be integrated together with a computer or other computing device.

The payment processor (140) may be configured to receive a user's (130) credentials and/or financial information and enable the user (130) to complete a financial transaction within the system (100). The financial transaction may be one where the user (130) purchases a completed multimedia album via the system (100).

The album manufacturer (150) may also be in communication with the system (100) to receive data associated with a completed multimedia album and enable the manufacturer (150) to print and reproduce the contents compiled and arranged by the system (100) into a finished album book.

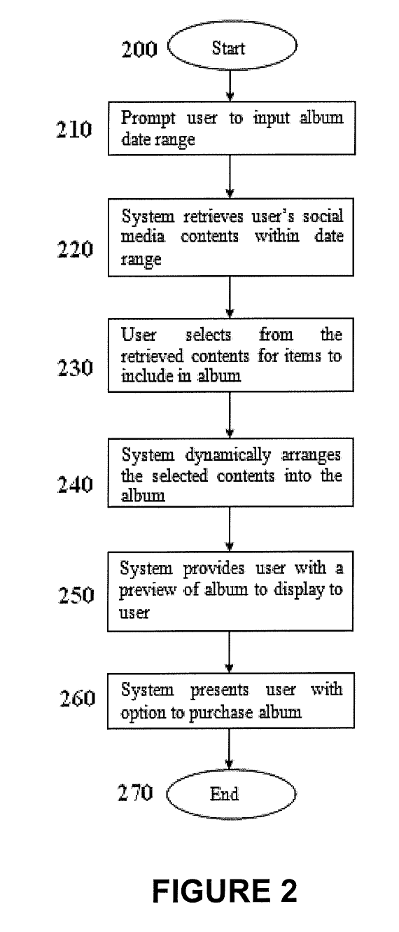

FIG. 2 depicts a flow diagram of a method for compiling and producing a multimedia album according to the system (100) depicted in FIG. 1. In step (200), the user (130) launches the multimedia album system (100) and starts the album creation process. In step (210), the user is prompted to input at least a first date range comprising a first start date and a first end date. Depending on the number of time periods the user (130) wishes to include, additional date ranges may also be added.

In step (220), the system (100) obtains the user's (130) inputted date range(s) and retrieve the user's (130) social media content that falls within the date range(s). The system may retrieve social media content that may be stored on the system (100), from external social media networks (110) and/or from local media networks (120). Where user name, password, and other credentials are require in order to access external social media sites, the user (130) may be prompted to provide the required information. In addition or in the alternative, the user may provide the system (100) with the required information ahead of time such that the system (100) may connect with external social media sites without user (130) interruption.

In step (230), the system (100) displays the retrieved social media content. The user (130) may then select items from the retrieved content that they wish to include in their multimedia album. In some versions, the system (100) enables the user (130) to upload additional content to include in their multimedia album. In some versions, the system (100) obtains and displays social media content such that associated content is also displayed together. For example, comments associated with selected photos or status updates may be displayed together and the user (130) may select whether to include this associated content.

In step (240), the system (100) takes the user's (130) content selections and dynamically arranges the content into the multimedia album. In some versions, the system (100) applies preformatted style sheets based on the volume, types, and/or sizes of the user's (130) selected contents to create a compiled multimedia album. In some versions, the system (100) may enable the user (130) to manually arrange, reposition, add, and/or delete content in their multimedia album. In some versions, the system (100) may enable the user (130) to add text or commentary. Any suitable degree of customization by the user (130) may be used as would be apparent to one of ordinary skill in the art in view of the teachings herein.

In step (250), once the system (100) has completed arranging the multimedia content in the current album, the system (100) may provide the user (130) with a preview of the compiled album. In some versions, the preview may appear as a part of the system's (100) graphical user interface. In some versions, the preview may appear as a pop-up window. In some versions, the preview may be available to the user (130) as a downloadable file.

In step (260), after the user (130) is presented with a preview of the compiled album, the system (100) may provide the user (130) with the option to purchase the completed album and checkout. In some versions, the system (100) may connect to a third party payment processor (140), such as PayPal or Google Checkout, to facilitate exchange of payment. In some versions, the system (100) may connect to an album manufacturer (150) and provide the manufacturer (150) with sufficient information and data to produce a physical copy of the multimedia album. In some versions, the system (100) may convert the album into a digital format for display on other devices, platforms, or applications.

In step (270), after the user (130) purchases an album or if the user (130) wishes to abort from the process, the album creation process ends. In some versions, the user (130) may be presented with the option to save their album to edit or to purchase in the future. In some versions, the saved album may be shared with others through an electronic medium, through social networking mediums, or through any other suitable medium as would be apparent to one of ordinary skill in the art in view of the teachings herein.

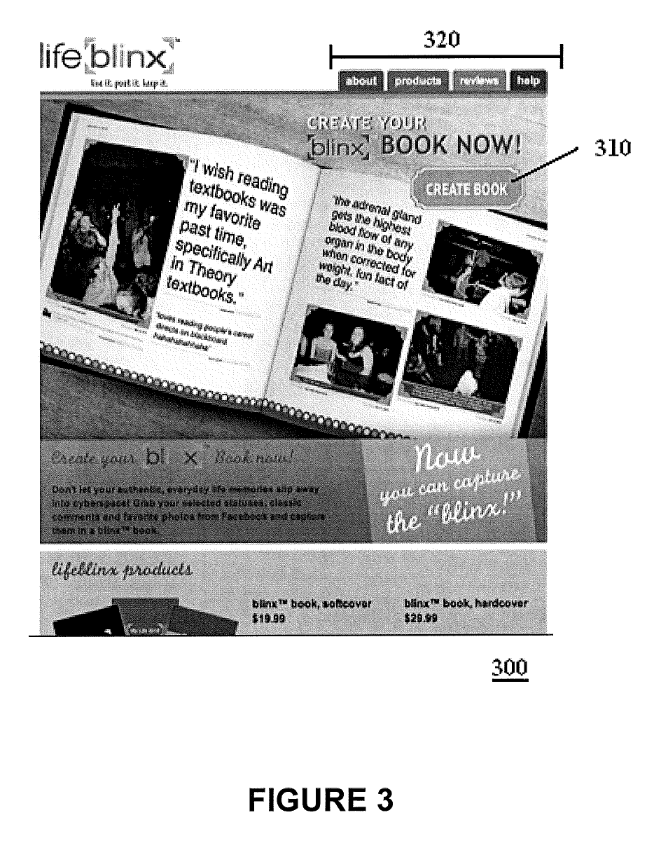

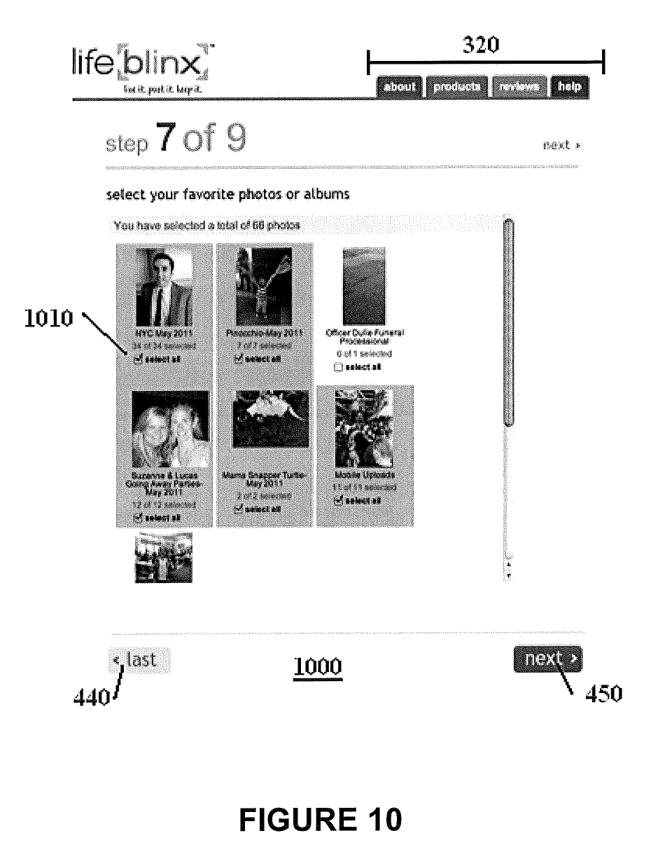

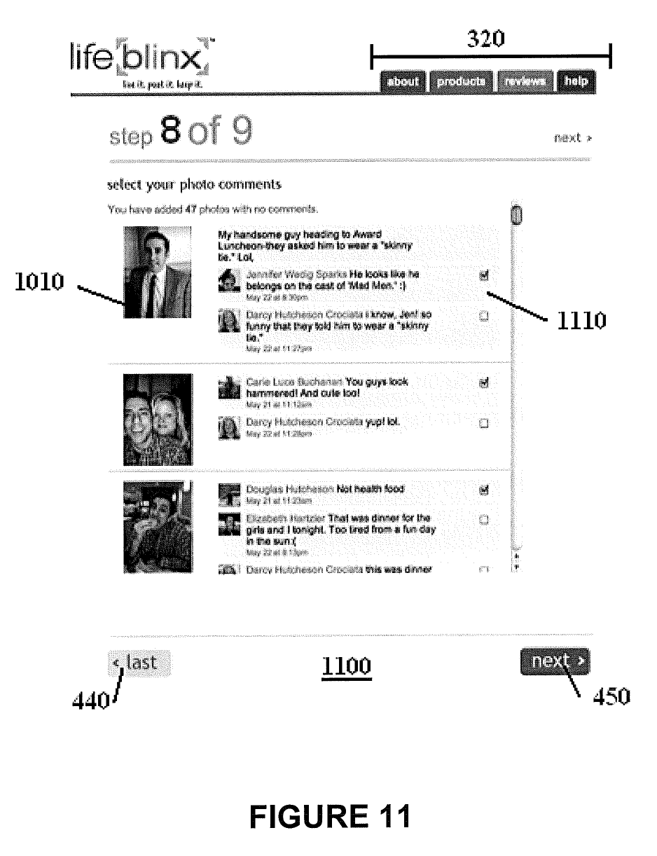

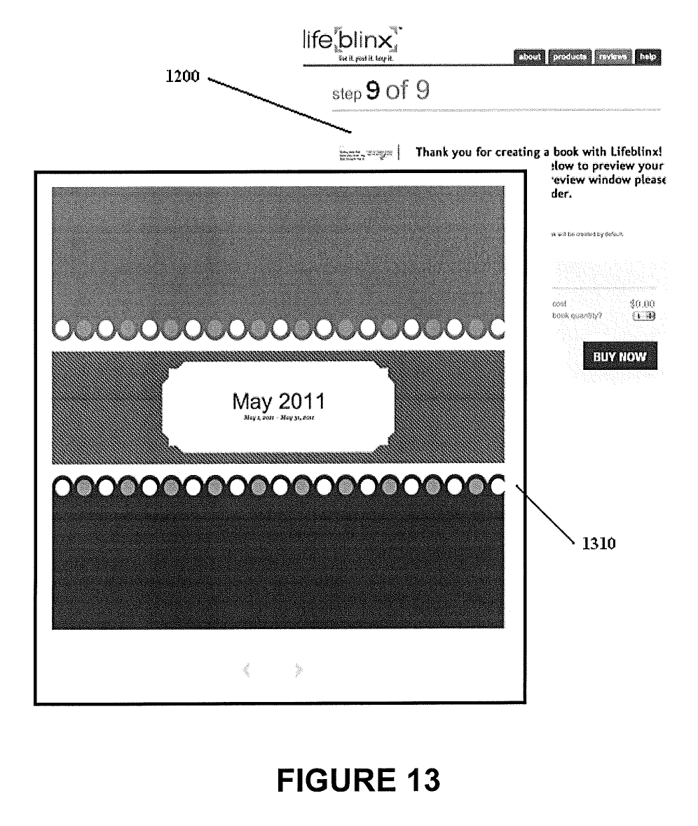

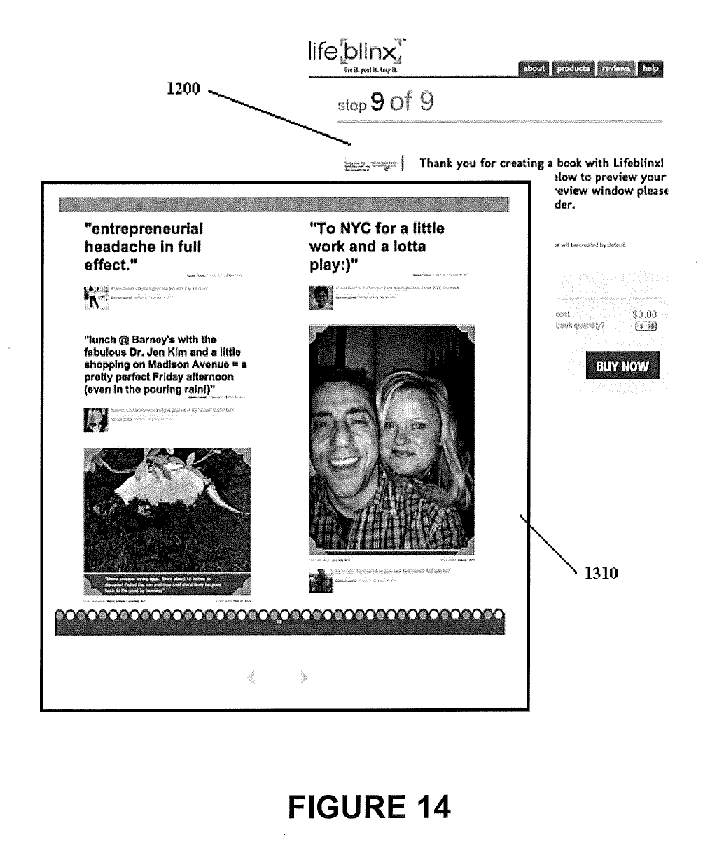

FIGS. 3-14 illustrate screen shots of one representative implementation of the system (100) following the general steps as depicted in FIG. 2. Of course, any other suitable graphical user interfaces or application layouts may be used as would be apparent to one of ordinary skill in the art in view of the teachings herein. Furthermore, steps shown in FIG. 2 may be interchanged with other steps of FIG. 2 and it will be appreciated that steps shown in FIG. 2 need not be necessarily carried out in the order shown in FIG. 2.

In FIG. 3, the system (100) displays an introduction page (300) to the user (130) with an option to start the multimedia album creation process. In some versions, the start option may be in the form of a button (310). In some versions, links or buttons (320) to information about the company, products, reviews, and help may be provided on the introduction page (300).

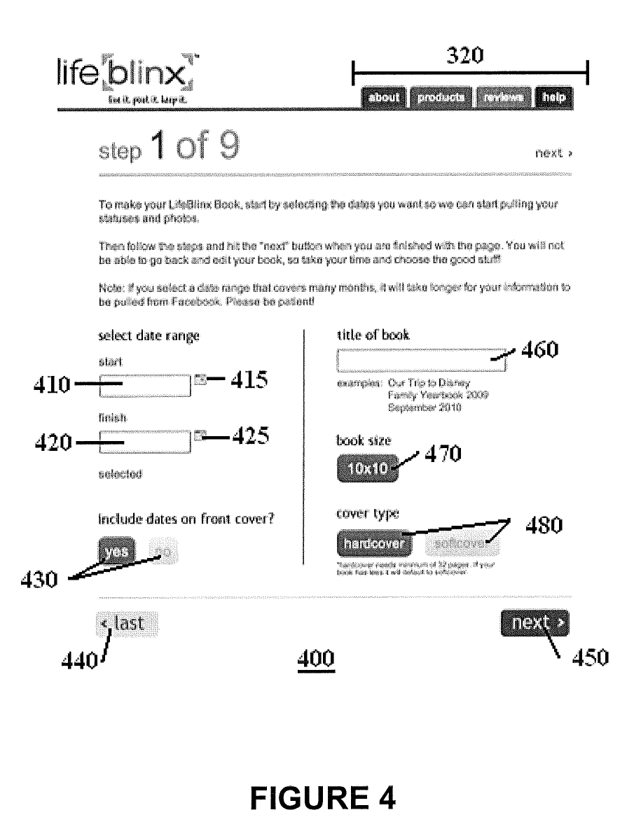

In FIG. 4, the system (100) may display a date range page (400) and prompts the user (130) to provide a date range for the album. In some versions, a start date entry field (410) and an end date entry field (420) may be provided. In addition or in the alternative, a start date visual calendar input (415) and an end date visual calendar input (425) may be provided. In some versions, other user inputs such as a front cover date option (430), album title entry (460), album size selection (470), and album cover type selection (480) may be provided. In some versions, a back or last button (440) and a next button (450) may be provided so that the user (130) can advance or return to a previous step in the album creation process.

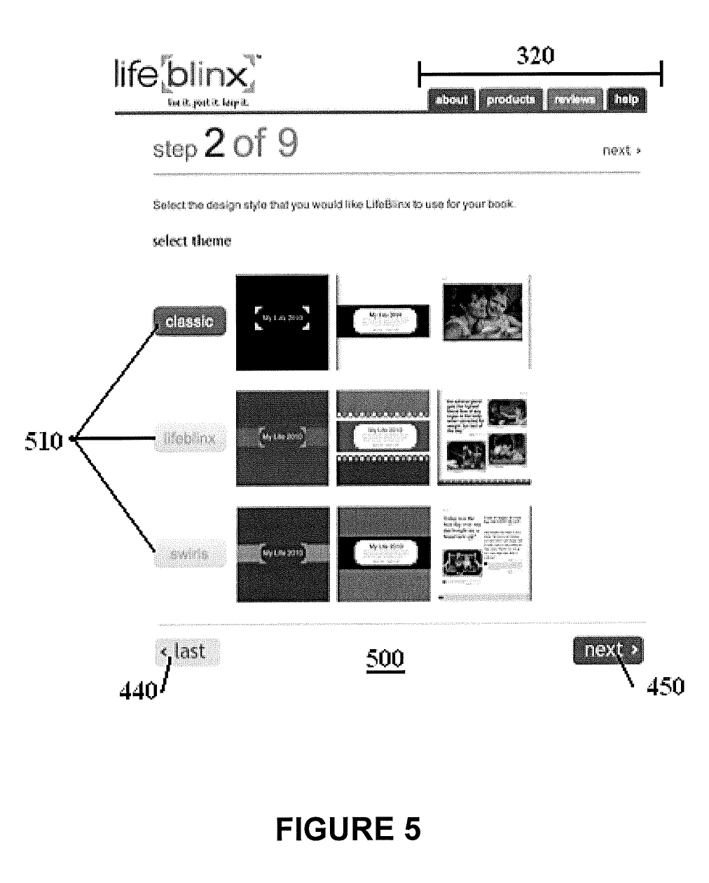

In FIG. 5, the system (100) may display a theme selection page (500) and prompt the user (130) to select a predefined album theme. In some versions, sample images of the themes' colors, fonts, covers, and page layouts are displayed on the theme selection page (500). In some versions, the theme selection page (500) may include a plurality of themes which are user selectable via theme selection buttons (510).

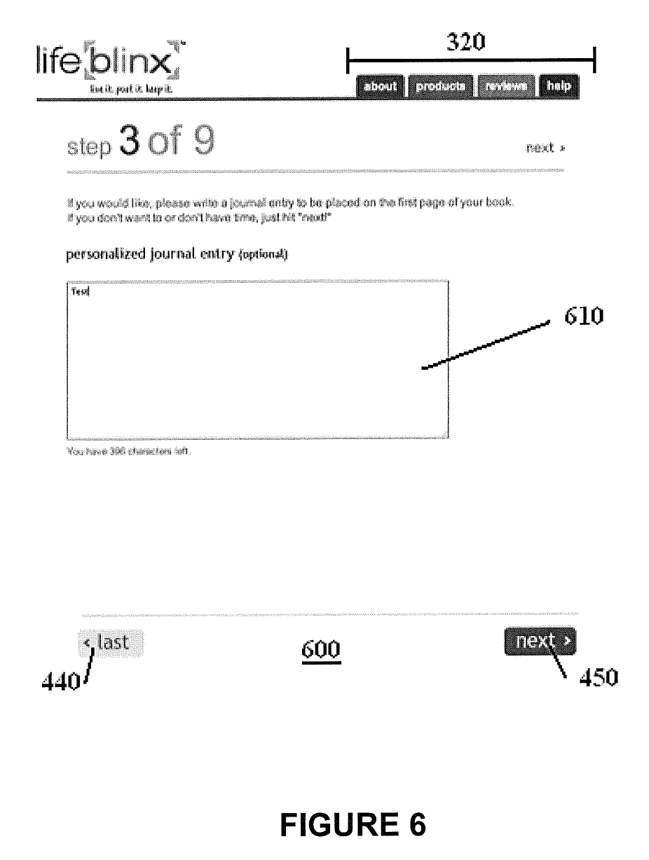

In FIG. 6, the system (100) may display a journal entry page (600) and prompt the user (130) to enter optional text to be displayed in the album. In some versions, the journal entry page (600) may include a text entry box (610).

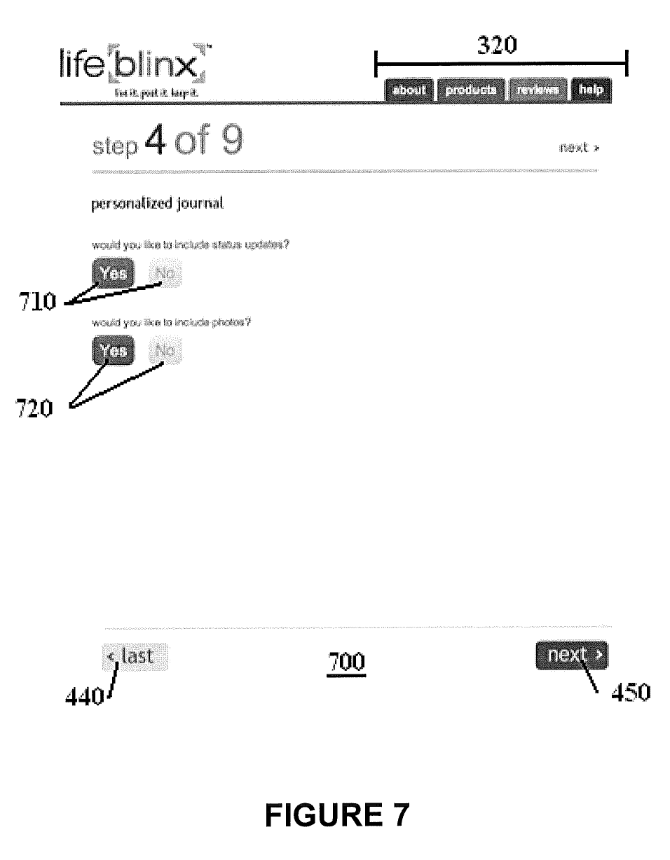

In FIG. 7, the system (100) may display a content-type selection page (700) and prompt the user (130) to select the type of multimedia contents to include. In some versions, the multimedia content types may include, but is not limited to, photos, notes, comments, status updates, blog posts, etc. In some versions, the content type selection page (700) may include selection buttons (710, 720) associated with each type of content for the user (130) to select from.

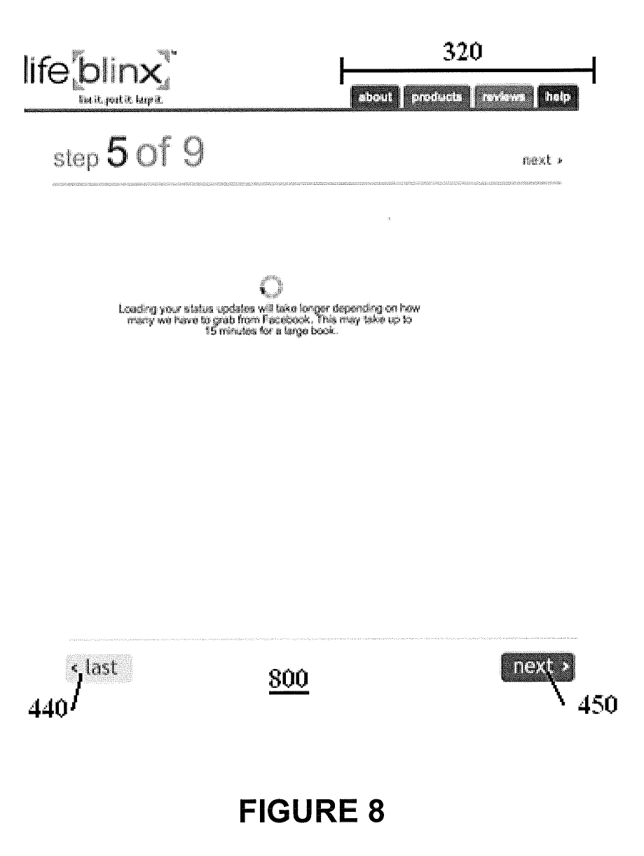

In FIG. 8, the system (100) may display a retrieval process screen (800) indicating that social media content and/or local media content is currently being retrieved from the applicable social media network (110) and/or local media network sources (120).

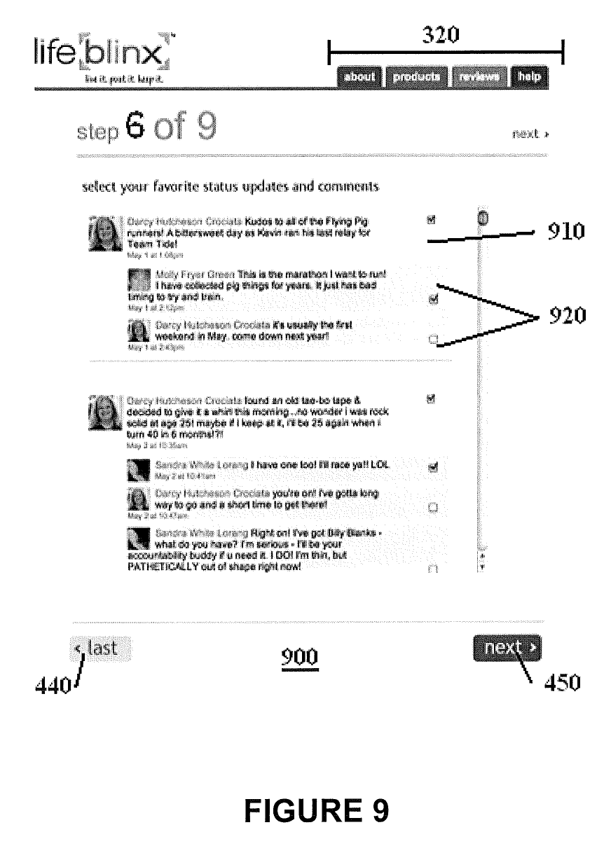

In FIGS. 9-11, the system (100) may display content selection pages (900, 1000, 1100) for the respective content-types previously selected by the user (130). In some versions, a first content selection page (900) may display retrieved status updates and associated contents within the user (130) provided date range(s). The first content selection page (900) may further provide an option to select and include specific status updates and associated comments or feedback.

In some versions, a second content selection page (1000) may display retrieved photos within the user (130) provided date range. The second selection page (1000) may further provide an option for user (130) to select and include specific photos (1010). Once the system (100) retrieves selection information from the second content selection page (1000), the system (100) may then obtain and display associated comments on a third selection page (1100) and may further provide an option for user (130) to select and include comments and other content associated with the photos (1110).

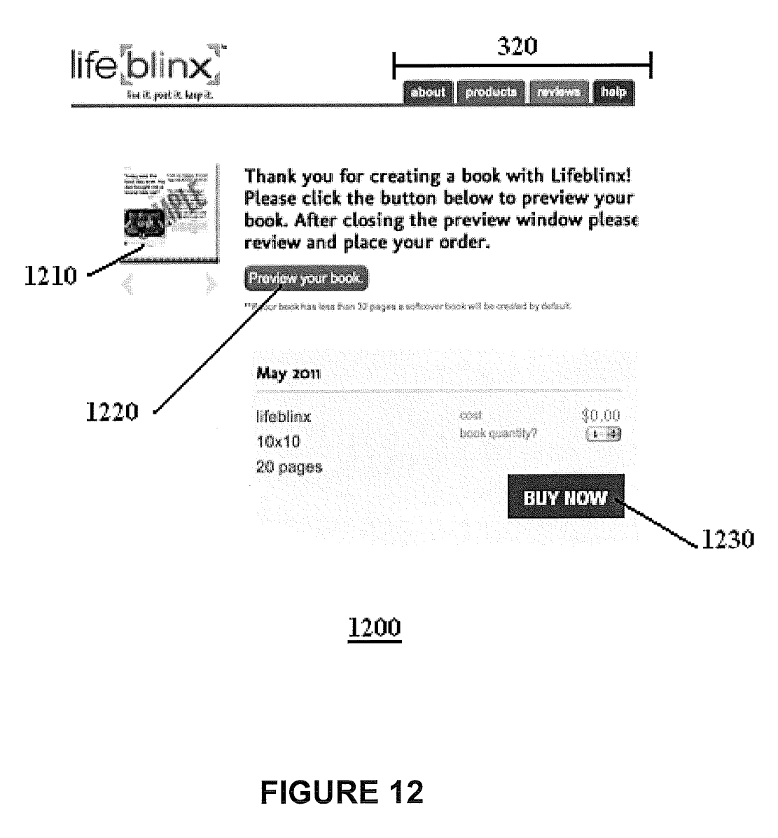

In FIGS. 12-14, the system (100) may display a review page (1200) of the compiled multimedia album and purchase options. In some versions, an embedded preview (1210) of the compiled album may be displayed to the user (130) and the user (130) is provided with options to navigate through the different pages of the album. In some versions, a preview link or preview button (1220) may be provided for the user (130) to open up a preview of the album to view either in a pop-up window (1310, 1410) or to download as a file. In some versions, a checkout link or checkout button (1230) may be provided to facilitate the purchase of the compiled album.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometries, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. A computerized method for creating a photograph album from digital photograph sources, the method comprising:
(a) receiving an input selection from a user, wherein the input selection is entered through a computing device;
(b) retrieving one or more photographs and contextual content from a digital photograph database stored on a second computing device based upon the input selection;
(c) including the one or more photographs and contextual content for the photograph album based upon the input selection;
(d) compiling the one or more photographs and contextual content into an arrangement based upon user input and a dynamic arrangement module; and
(f) creating a finalized version of the photograph album.

2. The method of claim 1, wherein the step of receiving the input selection comprises receiving a date range.

3. The method of claim 1, wherein the step of receiving the input selection comprises receiving a geographical location.

4. The method of claim 1, wherein the step of receiving the input selection comprises receiving a particular event.

5. The method of claim 1, wherein the step of receiving the input selection comprises selecting people on a social network.

6. The method of claim 1, further comprising producing a hard copy version of the photograph album.

7. The method of claim 6, further comprising transmitting the photograph album to a photograph album manufacturer to produce the hard copy version.

8. An apparatus comprising:
(a) a processor;
(b) a computer readable memory in communication with the processor, wherein the computer readable memory comprises executable code configured to:
(i) collect a input selection from a user;
(ii) connect to a social network;
(iii) arrange digitally stored photographs on the social network into a photograph album; and
(iv) add contextual content to the photograph album based upon the input selection.

9. The apparatus of claim 8, wherein the input selection comprises a date range.

10. The apparatus of claim 8, wherein the input selection comprises a geographic location.

11. The apparatus of claim 8, wherein the input selection comprises a particular event.

12. The apparatus of claim 8, wherein the input selection comprises selecting one or more persons.

13. The apparatus of claim 8, wherein the computer readable memory is further configured to give the user the option to purchase a hard copy of the photograph album.

14. The apparatus of claim 8, wherein the photographs are arranged in a chronological order.

15. The apparatus of claim 14, wherein the user is given the option to override the chronological order and place the digitally stored photographs in any order based on user input.

16. A computerized method of creating an album of digital pictures, the method comprising:
(a) receiving a user input through a computing device;
(b) retrieving one or more photographs wherein the one of more photographs is associated with the user input;
(c) collecting one or more items of social media content, wherein the one or more items of social media content are associated with the one or more photographs; and
(d) creating an album of digital pictures comprising the one or more photographs arranged with the one or more items of social media content.

17. The apparatus of claim 16, wherein the one or more items of social media content comprises a comment about the one or more photographs.

18. The apparatus of claim 16, wherein the one or more items of social media content comprises user generated content from a social media network.

19. The apparatus of claim 16, wherein the one or more items of social media content comprises computer generated graphics.

20. The apparatus of claim 16, wherein the one or more items of social media content comprises a caption describing the one or more photographs.
